(19) United States
(12) Patent Application Publication
(10) Pub. No.: US 2026/0251963 A1
(43) Pub. Date: Aug. 27, 2026

(54) SELF-SHIELDING CAMERA SYSTEM

(71) Applicant: TOSHIBA GLOBAL COMMERCE SOLUTIONS, INC., Durham, NC (US)

(72) Inventors: Suzanne M. BLEAKLEY, Cary, NC (US); Brad M. JOHNSON, Raleigh, NC (US)

(21) Appl. No.: 19/062,143

(22) Filed: Feb. 25, 2025

(51) Int. Cl. G03B 17/56; G06V 20/52

(52) U.S. Cl. CPC G03B 17/561; G06V 20/52

(57) ABSTRACT

The present disclosure provides techniques for using a controller to automatically shield a camera into a case in response to detecting an environmental hazard such as water, smoke, or heat, in an environment. By shielding the camera into the case, the camera is protected against the environmental hazard. The camera is automatically de-shielded when the environmental hazard is no longer present.

### BACKGROUND

Cameras used in venues, such as grocery stores, restaurants, or self-serve eateries, have been steadily increasing. These cameras are often in locations that can make the cameras susceptible to environmental hazards. The cameras could be sprayed with water from a misting system in a produce section or a sprinkling system, splashed with grease from a frying station in a restaurant, exposed to heat from a grilling station or an unintentional fire, or exposed to heavy smoke from a grilling station.

### BRIEF DESCRIPTION OF THE DRAWINGS

FIG. 1 depicts a shielding system communicatively coupled to a controller, according to one embodiment.

FIG. 2 depicts a flow diagram for detecting an environmental hazard and shielding a camera, according to one embodiment.

FIG. 3A depicts a camera protruding from a case, according to one embodiment.

FIG. 3B depicts the camera shielded in the case illustrated in FIG. 3A, according to one embodiment.

FIG. 4A depicts a camera protruding from a case, according to one embodiment.

FIG. 4B depicts the camera shielded in the case illustrated in FIG. 4A, according to one embodiment.

FIG. 5A depicts a camera protruding from a case.

FIG. 5B depicts the camera shielded in the case illustrated in FIG. 5A, according to one embodiment.

FIG. 6A depicts a camera inside a case.

FIG. 6B depicts the camera shielded in the case illustrated in FIG. 6A, according to one embodiment.

FIG. 7A depicts a camera protruding from a case.

FIG. 7B depicts the camera shielded in the case illustrated in FIG. 7A, according to one embodiment.

FIG. 8 depicts a flow diagram for de-shielding the camera.

### DETAILED DESCRIPTION

Embodiments of the present disclosure are directed to techniques for shielding a camera in response to an environmental hazard. Cameras installed in stores and restaurants can be affected by different environmental hazards such as water, smoke, or heat. By leaving a camera exposed to these environmental hazards, the camera’s lens can be coated with a film that reduces image quality, or the environmental hazards can damage the camera itself. The present disclosure recites a method of detecting the environmental hazards and shielding the camera into a case. Moreover, the technique does not have to rely on external sensors to detect the environmental hazards. Instead, the camera may capture images, and a system automatically checks the images for any environmental hazards. In one embodiment, the system determines there is an environmental hazard in one of the images captured by the camera, the camera is shielded in the system. In one embodiment, whenever the system determines that the environmental hazard is gone, the camera is de-shielded from the case.

### Advantages of a Self-shielding Camera System in Response to a Hazard

The embodiments herein provide techniques for shielding a camera into a case in response to an environmental hazard. By having the camera shield into the case, the hazard will cause less or no damage to the camera or protect a lens from the hazard.

The present disclosure provides an improvement in the technology of camera protection systems. The improved systems automatically shield and de-shield a camera from a case in response to environmental hazards (e.g. water from a misting system, smoke from a grilling station, grease from a fryer, or heat from an unintentional fire). By automatically shielding the camera, the camera avoids exposure to the hazard that could cause a film to form on a lens on the camera or damage the camera. Additionally, automatically de-shielding the camera allows the camera to quickly get back to capturing images after the hazard is removed. Moreover, automatically shielding and de-shielding can be performed without human intervention (e.g., a human shields the camera into a protective case) which is advantageous since many cameras are mounted in areas that are difficult to reach.

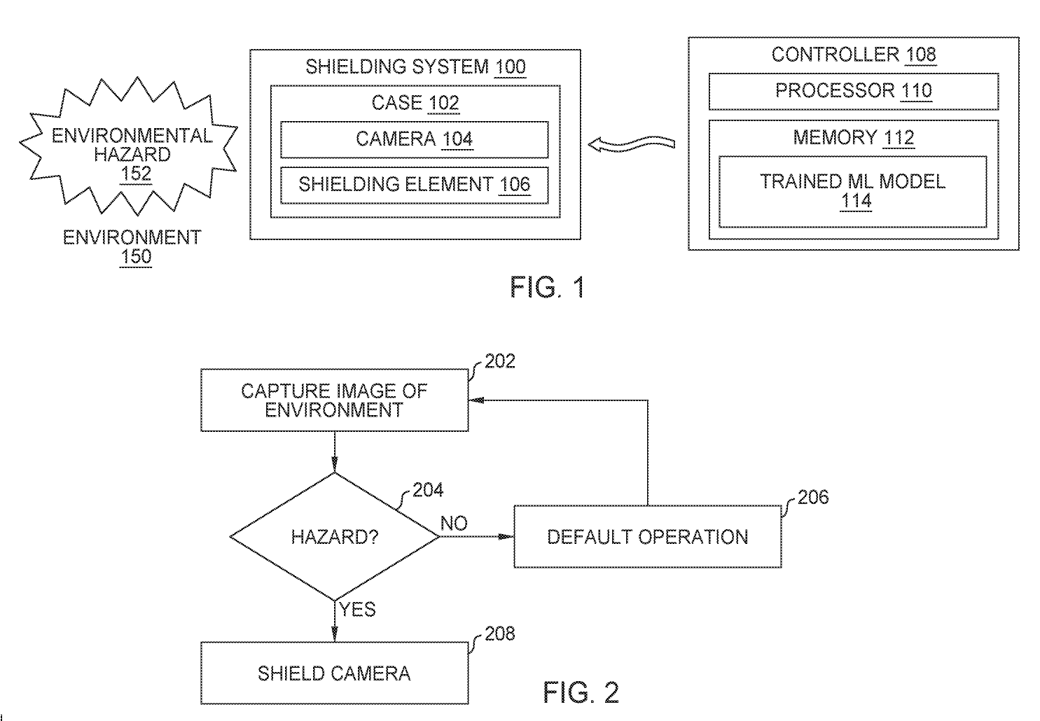

FIG. 1 illustrates a shielding system 100. The shielding system 100 includes a case 102, a camera 104, and a shielding element 106. The camera 104 (e.g., a depth camera, a visual camera, or an infrared camera) captures images of an environment 150. For example, the environment 150 may be a grocery store’s produce aisle where the camera 104 is used to capture images of produce to determine the produce’s quality (e.g., whether it is wilted or damaged) or if the produce is out of stock. The aisle may contain misters which periodically sprays the produce. However, if the mist reaches the camera 104, the mist could cause droplets of water to form on a lens of the camera 104 resulting in poor quality images or the mist could damage the camera 104 by getting into circuitry inside the camera 104. In another example, the environment 150 may be a restaurant where the camera 104 is used to track orders in a kitchen. The kitchen may contain grills that produce smoke from grilling food. However, if heavy smoke reaches the camera 104, the smoke could cover the lens of the camera 104 resulting in poor quality images. Further, the kitchen may contain fryers that can have oil popping out of the fryer. If the oil popping out of the fryer reaches the camera 104, the oil can cover the lens of the camera 104 resulting in poor quality images or damage to the camera 104 itself from the hot oil touching the lens. Furthermore, the kitchen may contain stoves with pots of boiling water for food. As a chef uncovers a lid on one of the pots, steam could be released from the pot. If the steam reaches the camera 104, the steam may condensate on the lens of camera 104 which can negatively impact image quality. Moreover, the water may enter the camera 104 and damage the lens or other circuitry of the camera 104. Mist, smoke, oil, and steam are just some examples of an environmental hazard 152 that could occur in the environment 150.

The shielding element 106 is used for shielding/de-shielding the camera 104 from the case 102. Examples of the shielding element 106 can be, but is not limited to, a motor with a worm gear, a pulley system, or a motor with a rotating bar. In one example, in response to the shielding system 100 receiving a signal that the environmental hazard 152 is in the environment 150, the motor activates the worm gear mechanism attached to the camera 104. In other examples, responsive to receiving the signal, the shielding system 100 causes the worm gear mechanism to rotate, retract, detract, move, or extend the camera into the case 104 by activating a translational rotation shift between the camera 104 and rotating bar. In another example, the worm gear mechanism moves the camera 104 into the case 102 at a rotational speed and direction. In an exemplary embodiment, in response to the shielding system 100 receiving a signal that the environmental hazard 152 is in the environment 150, the pulley system attached to the camera 104 and pulls the camera 104 into the case 102. In one example, in response to the shielding system 100 receiving a signal that the environmental hazard 152 is in the environment 150, the motor activates the rotating bar attached to the camera 104 and rotates the camera 104180 degrees into the case 102.

The shielding system 100 is connected to controller 108. The controller 108 includes a processor 110 and memory 112. For example, the controller 108 may be a computer with an application that operates the camera 104 under a default mode of operation. In one example, the default mode of operation includes monitoring items as part of a theft prevention system. These items can include, but are not limited to, groceries, electronics, and clothes. Another example of a default mode of operation is for detecting items at checkout, or for tracking food orders made by customers. The processor 110 represents any number of processing elements, which can each include any number of processing cores. The memory 112 can include volatile memory elements, non-volatile memory elements, and any combinations thereof. The memory 112 includes a trained machine learning (ML) model 114. The trained ML model 114 is trained to recognize a difference between people, items, and environmental hazards found in an image captured by the camera 104. By differentiating between a person, an item, and an environmental hazard, the controller 108 can shield the camera 104 when the controller 108 determines there is an environmental hazard.

The shielding system 100 may comprise a plurality of sensors to capture data of the environment 150. For example, the shield system may comprise a thermometer to capture a temperature of the environment 150, a humidity sensor to measure the air moisture of the environment 150, and/or a motion sensor to detect an object or person moving in the environment 150. In an exemplary embodiment, the shielding system 100 comprises an actuator that receives commands from the controller 108. For example, the actuator may receive a command to shield the camera 104 by rotating the camera 104 or moving a portion of the case 102. In an exemplary embodiment, in response to the shielding system 100 receiving a signal that the environmental hazard 152 is in the environment 150, the actuator works with the shielding element 106 to shield the camera 104 by rotating the camera 104 into the case 102. In an exemplary embodiment, in response to the shielding system 100 receiving a signal that the environmental hazard 152 is in the environment 150, the actuator works with the shielding element 106 by moving a portion of the case 102 to shield the camera 104.

FIG. 2 is a flow diagram of a method 200 for deciding to shield the camera 104 in response to detecting a hazard in the environment (e.g. the environmental hazard 152). At block 202, the camera 104 is operating under a default operation and capturing images of the environment 150. For example, a default mode of operation for the camera 104 may be tracking items in a store for loss prevention by watching for items taken from an aisle and not placed into a grocery cart/basket. The camera 104 can capture images of items in the store and the controller 108 automatically determines what is happening in an environment such as a store clerk putting items on a shelf or a customer putting items in a shopping cart.

Another example of a default mode of operation is tracking items scanned at a checkout station. As the camera 104 captures images of the environment 150, the controller 108 can determine that an item was scanned at the checkout station and may determine what specific item was scanned. Another example of a default mode of operation is determining when an item is out of stock on a shelf. As the camera 104 captures images of the environment 150, the controller 108 can determine there are shelves in the environment with items on the shelves. As the camera 104 continues to take images of the environment 150, the controller 108 can determine that the stock of an item is low. However, these are just a few examples of a default operation of the camera 104.

At block 204, one of the images captured by the camera 104 is analyzed by the controller 108 to determine if there is an environmental hazard in the environment 150. While the camera 104 is operating under a default mode of operation, the controller 108 can analyze the images using the trained ML model 114. The trained ML model 114 can use a method to identify the environmental hazards 152 including object recognition or other computer vision techniques. For example, the trained ML model 114 may be trained using object recognition to detect oil starting to bubble or when a lid on a pot is being opened. When the camera 104 captures an image of a fryer bubbling with oil, the controller 108 can determine using the trained ML model 114 that there is an environmental hazard, which is the bubbling oil, in the environment 150. This is only one example of how the trained ML model 114 can be trained and used to detect environmental hazards.

In response to the controller 108 not identifying an environmental hazard in the image, the method 200 proceeds to block 206 where the camera 104 continues to operate in the default operation, such as detecting items at checkout or tracking items for loss prevention.

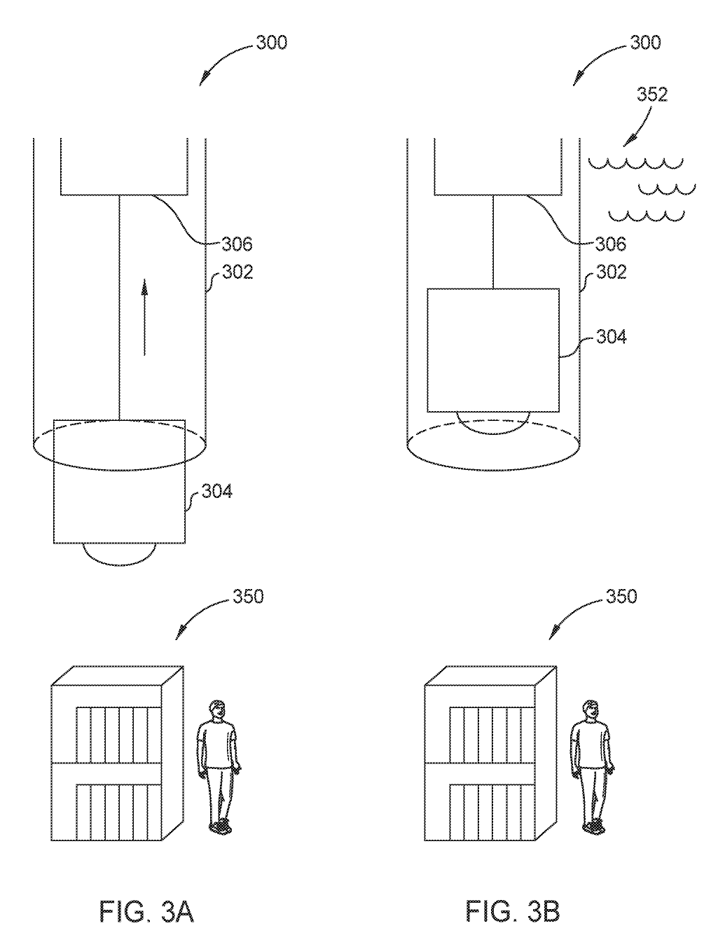

However, if at block 204 the controller 108 identifies an environmental hazard, such as the environmental hazard 152, then the method 200 proceeds to block 208 to shield the camera 104. FIGS. 3A-7B depict exemplary embodiments of shielding the camera 104 into the case 102.

FIG. 3A depicts a shielding system 300, such as the shielding system 100 in FIG. 1. The shielding system 300 includes a case 302, a camera 304, and a shielding element 306. For example, the case 302 may be cylindrical, rectangular, or spherical in shape. Moreover, the case 302 may be made of different materials such as metal, plastic, or any combination thereof. Furthermore, the material of the case 302 may be opaque, translucent, or transparent. The shielding system 300 is depicted as being in an environment 350 (e.g. a retail store or a restaurant). In this embodiment, the camera 304 is at least partially outside of the case 302 such that the camera 304 can capture images of the environment 350. As the camera 304 is capturing images of the environment 350, the images are analyzed by the controller 108 as described above.

While the camera 304 captures images of the environment 350, the controller 108 may be operating under a default operation mode, such as detecting items at a checkout station, and checking for an environmental hazard. When the camera 304 captures an image of an environmental hazard, such as environmental hazard 352 in FIG. 3B, the shielding element 306 shields the camera 304 into the case 302 to protect the camera 304 from the environmental hazard 352. In the exemplary embodiment shown in FIG. 3B, the shielding element 306 linearly retracts the camera 304 into the case 302 such that the camera 304 is fully inside of the case 302. For example, the shielding element 306 may be a motor with a worm gear or a pulley system. In the exemplary embodiment, the case 302 may not cover an end of the case 302 such that the camera 304 is at least partially exposed to the environment 350. While the end of the case 302 is not covered, the camera 304 is still protected from environmental hazards such as water from a sprinkler system or other environmental hazards that would interact with a side of the case 302.

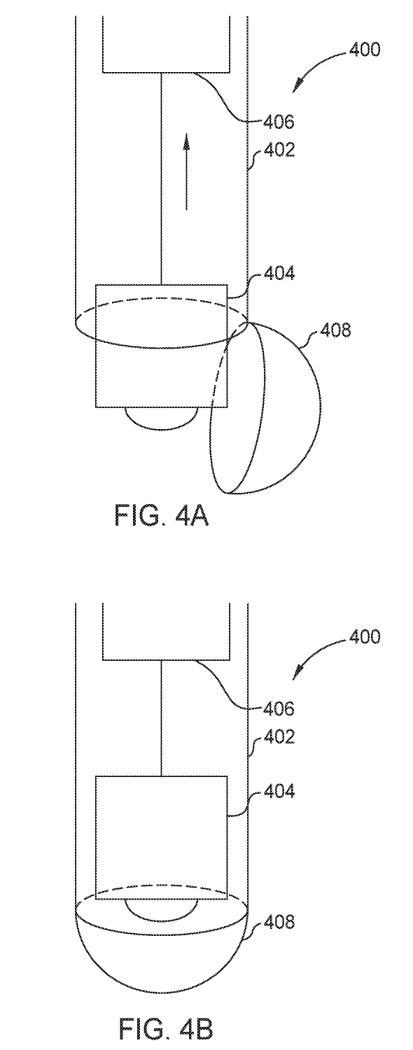

FIGS. 4A and 4B depict another exemplary embodiment of a shielding system 400, such as the shielding system 100 shown in FIG. 1. The shielding system 400 includes a case 402, a camera 404, a shielding element 406, and a lid 408. For example, the case 402 may be cylindrical, rectangular, or spherical in shape. Moreover, the case 402 may be made of different materials such as metal, plastic, or any combination thereof. Furthermore, the material of the case 402 may be opaque, translucent, or transparent. The lid 408 may be shaped to match a shape of an end of the case 402. For example, if the case 402 is cylindrical in shape, the lid 408 may be circular or hemispherical in shape. Moreover, if the case 402 is rectangular in shape, the lid 408 may also be rectangular in shape. Furthermore, if the case 402 is spherical in shape, the lid 408 may be hemispherical in shape. In an exemplary embodiment, the lid 408 is made of the same materials as the case 402. In another exemplary embodiment, the lid 408 is made of a different material from the case 402. Furthermore, the material of the lid 408 may be opaque, translucent, or transparent.

The camera 404, the shielding element 406, and the lid 408 are coupled to the case 402. Additionally, the camera 404 is coupled to the shielding element 406. In FIG. 4A, the camera 404 is at least partially outside of the case 402 such that the camera 404 can capture images of an environment, such as the environment 150. While the camera 404 is at least partially outside of the case 402, the lid 408 is in an open position. As the camera 404 is capturing images of the environment 150, the images are analyzed by the controller 108 as described above.

While the camera 404 captures images of the environment 150, the controller 108 is operating under a default operation, such as detecting items at a checkout station, and checking for an environmental hazard. When the camera 404 captures an image of an environmental hazard, such as the environmental hazard 152, the shielding element 406 shields the camera 404 into the case 402. As shown in FIG. 4B, the shielding element 406 linearly retracts the camera 404 into the case 402 such that the camera 404 is fully inside the case 402. For example, the shielding element 406 may be a motor with a worm gear or a pulley system. As part of shielding the camera 404 into the case 402, the lid 408 automatically closes onto the case 402 in a closed position. In an exemplary embodiment, the lid 408 is spring-loaded. Unlike the exemplary embodiment described in FIG. 3B, by closing the lid 408 onto the case 402, the camera 404 is protected from environmental hazards interacting with a side of the case 402 and environmental hazards that interact with a bottom of the case 402. While the lid 408 is in the closed position, the camera 404 is not exposed to the environment 150.

In an exemplary embodiment, the lid 408 is transparent such that the camera 404 can capture images of the environment 150 through the lid 408. As the camera 404 is shielded, the camera 404 is able to capture images of the environment 150 through the transparent lid 408. Then, the controller 108 can analyze the captured images to determine if the environmental hazard 152 is still present.

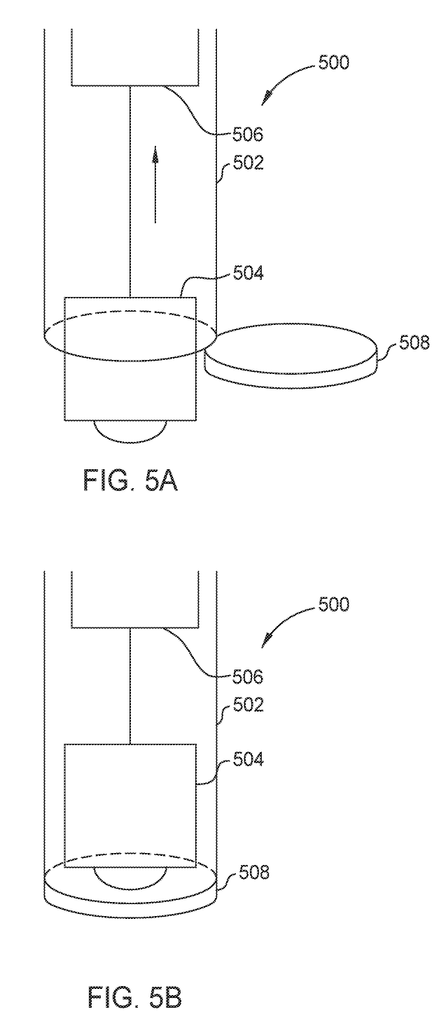

Similarly, FIGS. 5A and 5B depict an exemplary embodiment of a shielding system 500, such as the shielding system 100 shown in FIG. 1. The shielding system 500 includes a case 502, a camera 504, a shielding element 506, and a lid 508. For example, the case 502 may be cylindrical, rectangular, or spherical in shape. Moreover, the case 502 may be made of different materials such as metal, plastic, or any combination thereof. Furthermore, the material of the case 502 may be opaque, translucent, or transparent. The lid 508 may be shaped to match a shape of an end of the case 502. For example, if the case 502 is cylindrical in shape, the lid 508 may be circular or hemispherical in shape. Moreover, if the case 502 is rectangular in shape, the lid 508 may also be rectangular in shape. Furthermore, if the case 502 is spherical in shape, the lid 508 may be hemispherical in shape. In an exemplary embodiment of the lid 508, the lid 508 is made of the same materials as the case 502. In another exemplary embodiment, the lid 508 is made of a different material from the case 502. Furthermore, the material of the lid 508 may be opaque, translucent, or transparent.

The camera 504, the shielding element 506, and the lid 508 are coupled to the case 502. Additionally, the camera 504 and the lid 508 are coupled to the coupling shielding element 506. In FIG. 5A, the camera 504 is at least partially outside of the case 502 such that the camera 504 can capture images of an environment, such as the environment 150. While the camera 504 is at least partially outside of the case 502, the lid 508 is in an open position. As the camera 504 is capturing images of the environment 150, the images are analyzed by the controller 108 as described above.

While the camera 504 captures images of the environment 150, the controller 108 is operating under a default operation, such as detecting items at a checkout station, and checking for an environmental hazard. When the camera 504 captures an image of an environmental hazard, such as the environmental hazard 152, the shielding element 506 shields the camera 504 into the case 502. As shown in FIG. 5B, the shielding element 506 linearly retracts the camera 504 into the case 502 such that the camera 504 is fully inside the case 502. For example, the shielding element 506 may be a motor with a worm gear or a pulley system. As part of the shielding process, the shielding element 506 moves the lid 508 into a closed position onto the case 502 as the camera 504 is linearly retracted into the case 502. By closing the lid 508 onto the case 502, the camera 504 is protected from the environmental hazard 152.

In an exemplary embodiment, the lid 508 is transparent such that the camera 504 can capture images of the environment 150 through the lid 508. As the camera 504 is shielded, the camera 504 is able to capture images of the environment 150 through the transparent lid 508. Then, the controller 108 can analyze the captured images to determine if the environmental hazard 152 is still present.

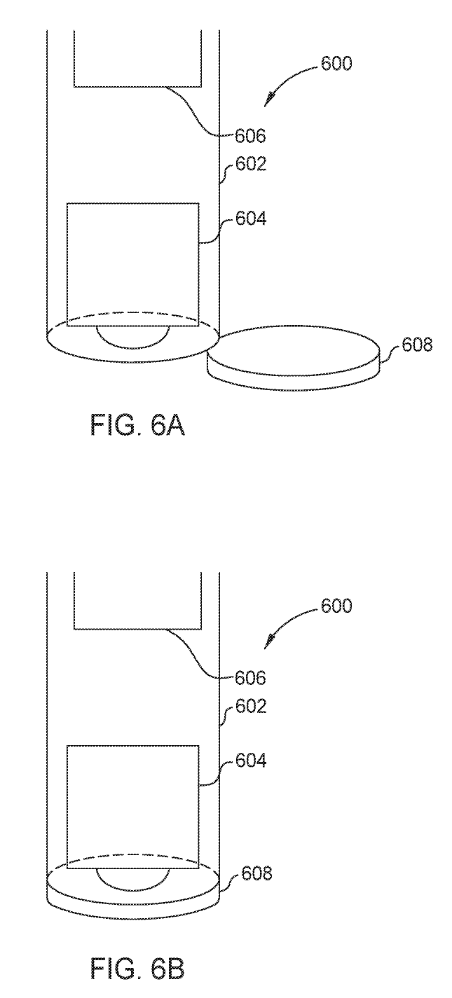

FIGS. 6A and 6B depict an exemplary embodiment of a shielding system 600, such as the shielding system 100 shown in FIG. 1. The shielding system 600 includes a case 602, a camera 604, a shielding element 606, and a lid 608. For example, the case 602 may be cylindrical, rectangular, or spherical in shape. Moreover, the case 602 may be made of different materials such as metal, plastic, or any combination thereof. Furthermore, the material of the case 602 may be opaque, translucent, or transparent. The lid 608 may be shaped to match a shape of an end of the case 602. For example, if the case 602 is cylindrical in shape, the lid 608 may be circular or hemispherical in shape. Moreover, if the case 602 is rectangular in shape, the lid 608 may also be rectangular in shape. Furthermore, if the case 602 is spherical in shape, the lid 608 may be hemispherical in shape. In an exemplary embodiment, the lid 608 is made of the same materials as the case 602. In another exemplary embodiment, the lid 608 is made of a different material from the case 602. Furthermore, the material of the lid 608 may be opaque, translucent, or transparent.

The camera 604, the shielding element 606, and the lid 608 are coupled to the case 602. Additionally, the lid 608 is coupled to the shielding element 606. In both FIGS. 6A and 6B, the camera 604 remains stationary inside of the case 602 as the camera 604 captures images of the environment 150. As the camera 604 captures images of the environment 150, the images are analyzed by the controller 108 as described above.

While the camera 604 captures images of the environment 150, the controller 108 is operating under a default operation, such as detecting items at a checkout station, and checking for an environmental hazard. When the camera 604 captures an image of an environmental hazard, such as the environmental hazard 152, the shielding element 606 shields the camera 604 by moving the lid 608 into a closed position onto the case 602. For example, the shielding element 606 may be a motor with a bar connected to the lid 608, a pulley system, or a person moving the lid 608 into the closed position. By closing the lid 608 onto the case 602, the camera 604 is protected from the environmental hazard 152.

In an exemplary embodiment, the lid 608 is transparent such that the camera 604 can capture images of the environment 150 through the lid 608. As the camera 604 is shielded, the camera 604 is able to capture images of the environment 150 through the transparent lid 608. Then, the controller 108 can analyze the captured images to determine if the environmental hazard 152 is still present.

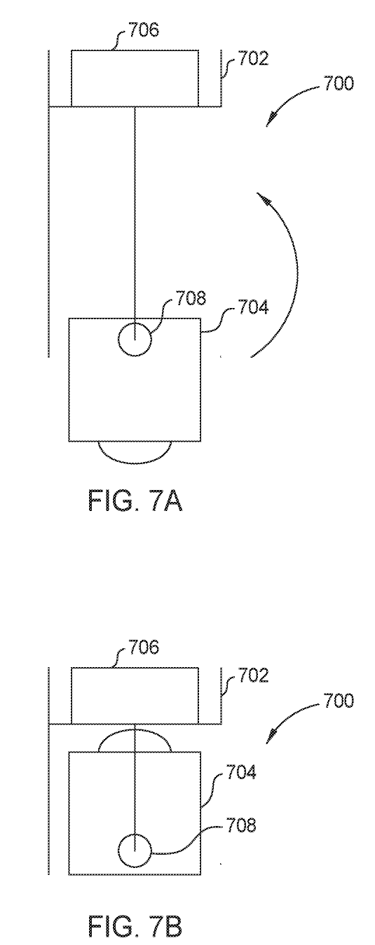

FIGS. 7A and 7B depict an exemplary embodiment of a shielding system 700, such as the shielding system 100 shown in FIG. 1. The shielding system 700 includes a case 702, a camera 704, and a shielding element 706. For example, the case 702 may be cylindrical or rectangular in shape. Moreover, the case 702 may be made of different materials such as metal, plastic, or any combination thereof. Furthermore, the material of the case 702 may be opaque, translucent, or transparent.

The camera 704 is coupled to the shielding element 706. The shielding element 706 is coupled to the case 702 at pivot point 708. In FIG. 7A, the camera 704 is at least partially below the case 702 such that the camera 704 can capture images of an environment, such as the environment 150. As the camera 704 is capturing images of the environment 150, the images are analyzed by the controller 108 described above.

While the camera 704 captures images of the environment 150, the controller 108 is operating under a default operation, such as detecting items at a checkout station, and checking for an environmental hazard. When the camera 704 captures an image of an environmental hazard, such as the environmental hazard 152, the shielding element 706 shields the camera 704 into the case 702. For example, the shielding element 706 may be a rotating bar. As shown in FIG. 7B, the shielding element 706 shields the camera 704 by rotating the camera 704 around the pivot point 708 along an axis a number of degrees such that a lens of the camera 704 is facing the case 702. In an exemplary embodiment, the shielding element 706 rotates the camera 704 180 degrees around the pivot point 708 to shield the camera 704 as illustrated by the arrow in FIG. 7A.

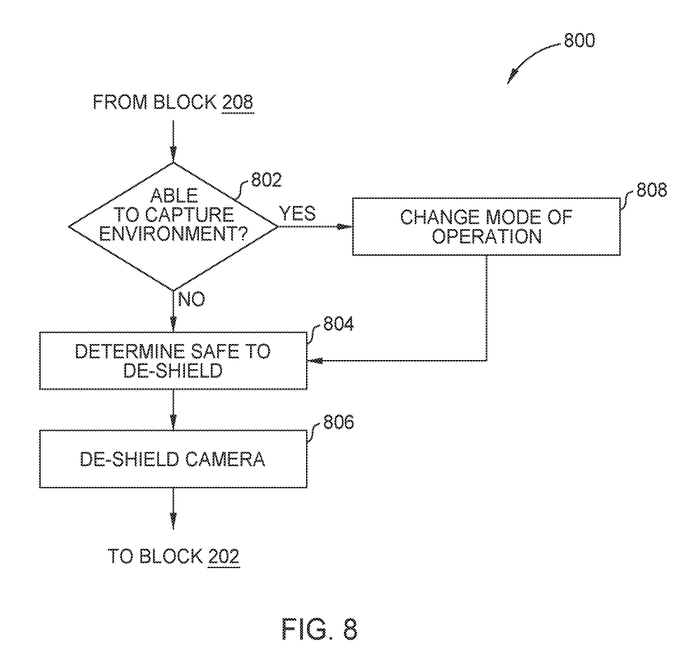

As the controller 108 finishes method 200 by shielding the camera 104 in block 208, the controller 108 transitions to block 802 of method 800 in FIG. 8. At block 802, the controller 108 determines if the camera 104 is able to capture images of the environment 150 while shielded. Examples of when the camera 104 would be able to still capture images of the environment 150 while shieled are: if a case doesn’t have a lid and the camera 104 is still facing the environment 150, such as FIG. 3B; or if a case has a transparent lid and the camera 104 is still facing the environment 150, as described above as embodiments in FIGS. 4B, 5B, and 6B.

If the camera 104 is able to capture images of the environment 150, the controller 108 moves to block 808. At block 808, the controller 108 changes the mode of operation for the camera 104 from a default operation to a second mode operation that is different from the default operation. For example, a default mode of operation of the camera 104 may be tracking items scanned at a checkout station. An example of the second mode of operation could be changing the camera 104 to use infrared to track customers when there is an environmental hazard, such as the environmental hazard 152, obscuring the view of the camera 104. By changing the mode of operation of the camera 104 in response to an environmental hazard, the camera 104 can continue to capture images of the environment 150.

In one example, when the camera 104 can capture the environment 150, the controller 108 moves to block 804. In block 804, the controller 108 determines that it is safe to de-shield the camera 104. An example of determining if it is safe to de-shield the camera 104 is by the camera 104 capturing images of the environment 150. In another example, the controller 108 may determine that it is safe to de-shield the camera 104 based on a measurement from a sensor in the shielding system 100. For example, the controller 108 may receive temperature data, from a thermometer, for the environment 150 indicating that the environment is 70°F (or 21° C), which is indicative that it is safe for the camera 104 to de-shield. In another example, the controller 108 may receive, from a humidity sensor, data about the humidity in the environment 150 indicating that there is a low humidity, which is indicative that it is safe for the camera 104 to de-shield. In another example, the controller 108 may receive data from a motion sensor indicating that there are no moving objects or people in the environment 150, which is indicative that it is safe for the camera 104 to de-shield. As the camera 104 is shielded, the camera 104 can continue to capture images of the environment 150 to determine if the environmental hazard 152 is still present.

Another example of how the controller 108 determines if it is safe to de-shield the camera 104 is by a timer. As the camera 104 is shielded into the case 102, the controller 108 starts a timer that indicates how long the camera 104 should stay shielded. As the timer finishes, the controller 108 determines that the environmental hazard 152 is no longer present. In an exemplary embodiment, the duration of the timer may be based on a known duration of an environmental hazard such as the duration of a mister in a produce section of a grocery store.

In another example, a user may indicate to the controller 108 that it is safe for the camera 104 to de-shield.

Responsive to determining the environmental hazard 152 is no longer present, the method 800 moves to block 806 where the controller 108 de-shields the camera 104. An exemplary embodiment of de-shielding the camera 104 is shown by the camera 304 depicted in FIG. 3A. The camera 304 is de-shielded by the shielding element 306 moving the camera 304 such that the camera 304 is at least partially outside of the case 302.

Another exemplary embodiment of de-shielding the camera 104 is shown by the camera 404 depicted in FIG. 4A. The camera 404 is de-shielded by the shielding element 406 moving the camera 404 such that the camera 404 is at least partially outside of the case 402. As the camera 404 moves out of the case 402, the camera 404 moves the lid 408 to an open position.

Another exemplary embodiment of de-shielding the camera 104 is shown by the camera 504 depicted in FIG. 5A. The camera 504 is de-shielded by the shielding element 506 moving the camera 504 such that the camera 504 is at least partially outside of the case 502. Also, the shielding element 506 moves the lid 508 into an open position.

Another exemplary embodiment of de-shielding the camera 104 is shown by the camera 604 depicted in FIG. 6A. The camera 604 is de-shielded by the shielding element 606 moving the lid 608 into an open position.

Another exemplary embodiment of de-shielding the camera 104 is shown by the camera 704 depicted in FIG. 7A. The camera 704 is de-shielded by the shielding element 706 rotating the camera 504 along an axis such that the camera 704 is at least partially below the case 702.

After de-shielding the camera 104 from the case 102, the controller 108 proceeds back to block 202 in FIG. 2. The camera 104 proceeds with capturing images of the environment under a default operation while checking for any environmental hazards in the environment 150.

In an exemplary embodiment, there is a plurality of cameras set up in a store, where each of the cameras can detect a hazard in the environment 150. If one of the plurality of cameras can detect a hazard in the environment 150, then the camera that detected the hazard is able to notify the rest of the plurality of cameras of the hazard in the environment 150. The plurality of cameras can notify each other over methods such as Wi-Fi or other suitable communication techniques. In response, each of the plurality of cameras can shield into the case as described above.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference was made to embodiments presented in this disclosure. However, the scope of the present disclosure is not limited to the described embodiments. Instead, any combination of the features and elements described herein, whether related to different embodiments or not, is contemplated to implement and practice contemplated embodiments. Furthermore, although embodiments disclosed herein may achieve advantages over other possible solutions or over the prior art, whether or not an advantage is achieved by a given embodiment is not limiting of the scope of the present disclosure. Thus, the aspects, features, embodiments and advantages discussed herein are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Aspects of the described embodiments may take the form of an entirely hardware embodiment, an entirely software embodiment (including firmware, resident software, micro-code, etc.) or an embodiment combining software and hardware aspects that may generally be referred to herein as a “circuit,” “module” or “system.”

One or more of the described embodiments may be a system, a method, and/or a computer program product. The computer program product may include a computer readable storage medium (or media) having computer readable program instructions thereon for causing a processor to carry out aspects of the embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the described embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the "C" programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the described embodiments.

Aspects of the described embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a described manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to one or more embodiments, other and further embodiments may be devised without departing from the basic scope thereof, and the scope thereof is determined by the claims that follow.

What is claimed is:

1. A method comprising:
capturing, by a camera coupled to a case, a first image of an environment;
identifying, by analyzing the first image, an environmental hazard in the first image; and
responsive to identifying the environmental hazard, retracting the camera within the case.

2. The method of claim 1, wherein identifying, by analyzing the first image, comprises using a trained machine learning (ML) model to perform object recognition using the first image.

3. The method of claim 1, wherein a lid is coupled to the case.

4. The method of claim 3, wherein the lid is transparent such that the camera can capture images through the lid.

5. The method of claim 1, wherein retracting the camera into the case comprises linearly retracting the camera into the case.

6. The method of claim 1, wherein retracting the camera into the case comprises rotating the camera along an axis into the case.

7. The method of claim 1, wherein responsive to identifying the environmental hazard, retracting the camera into the case comprises the camera remaining stationary and moving a lid onto the case to cover the camera.

8. The method of claim 1, further comprises, after retracting the camera:
capturing, by the camera, a second image of the environment;
identifying, by analyzing the second image, that the environmental hazard is no longer present; and
responsive to identifying that the environmental hazard is no longer present, de-retracting the camera.

9. The method of claim 8, further comprising starting a second mode of operation that is different from a default mode of operation.

10. The method of claim 1, further comprising:
initiating a timer when the camera is retracted; and
responsive to determining the timer has expired, de-retracting the camera.

11. A retracting system comprising:
a case;
a camera coupled to the case; and
a retracting element coupled to the case, wherein the retracting element is communicatively coupled to a controller, the controller configured to:
capture, by the camera, a first image of an environment;
identify, by analyzing the first image, an environmental hazard in the first image; and
responsive to identifying the environmental hazard, retract the camera within the case using the retracting element.

12. The retracting system of claim 11, wherein identifying, by analyzing the first image, comprises using a trained machine learning (ML) model to perform object recognition using the first image.

13. The retracting system of claim 11, wherein a lid is coupled to the case.

14. The retracting system of claim 13, wherein the lid is transparent such that the camera can capture images through the lid.

15. The retracting system of claim 11, wherein retracting the camera into the case comprises linearly retracting the camera into the case.

16. A computer-readable storage medium having computer-readable program code embodied therewith, the computer-readable program code executable by one or more computer processors to perform operations, the operations comprising:
capture, by a camera coupled to a case, a first image of an environment;
identify, by analyzing the first image, an environmental hazard in the first image; and
responsive to identifying the environmental hazard, retract the camera within the case.

17. The computer-readable storage medium of claim 16, wherein identifying, by analyzing the first image, comprises using a trained machine learning (ML) model to perform object recognition using the first image.

18. The computer-readable storage medium of claim 16, further comprises, after retracting the camera:
capturing, by the camera, a second image of the environment;
identifying, by analyzing the second image, that the environmental hazard is no longer present; and
responsive to identifying that the environmental hazard is no longer present, de-retracting the camera.

19. The computer-readable storage medium of claim 18, further comprising starting a second mode of operation that is different from a default mode of operation.

20. The computer-readable storage medium of claim 16, further comprising:
initiating a timer when the camera is retracted; and
responsive to determining the timer has expired, de-retracting the camera.
